(19) United States
(12) Patent Application Publication
(10) Pub. No.: US 2010/0283829 A1
(43) Pub. Date: Nov. 11, 2010

(54) SYSTEM AND METHOD FOR TRANSLATING COMMUNICATIONS BETWEEN PARTICIPANTS IN A CONFERENCING ENVIRONMENT

(75) Inventors: Marthinus F. De Beer, Los Gatos, CA (US); Shmuel Shaffer, Palo Alto, CA (US)

Correspondence Address: Patent Capital Group - Cisco, 6119 McCommas, Dallas, TX, 75214, US

(73) Assignee: Cisco Technology, Inc.

(21) Appl. No.: 12/463,505

(22) Filed: May 11, 2009

(51) Int. Cl. H04N 7/15; G06F 17/28

(52) U.S. Cl. 348/14.09; 704/2; 704/E17.001; 348/E07.084

(57) ABSTRACT

A method is provided in one example embodiment and includes receiving audio data from a video conference and translating the audio data from a first language to a second language, wherein the translated audio data is played out during the video conference. The method also includes suppressing additional audio data until the translated audio data has been played out during the video conference. In more specific embodiments, the video conference includes at least a first end user, a second end user, and a third end user. In other embodiments, the method may include notifying the first and third end users of the translating of the audio data. The notifying can include generating an icon for a display being seen by the first and third end users, or using a light signal on a respective end user device configured to receive audio data from the first and third end users.

### TECHNICAL FIELD

This disclosure relates in general to the field of communications and, more particularly, to translating communications between participants in a conferencing environment.

### BACKGROUND

Video services have become increasingly important in today's society. In certain architectures, service providers may seek to offer sophisticated video conferencing services for their end users. The video conferencing architecture can offer an “in-person” meeting experience over a network. Video conferencing architectures can deliver real-time, face-to-face interactions between people using advanced visual, audio, and collaboration technologies. Some issues have arisen in video conferencing scenarios when translations are needed between end users during a video conference. Language translation during a video conference presents a significant challenge to developers and designers, who attempt to offer a video conferencing solution that is realistic and that mimics a real-life meeting between individuals sharing a common language.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified schematic diagram of a communication system for translation communications in a conferencing environment in accordance with one embodiment;

FIG. 2 is a simplified block diagram illustrating additional details related to an example infrastructure of the communication system in accordance with one embodiment; and

FIG. 3 is a simplified flowchart illustrating a series of example steps associated with the communication system.

### DETAILED DESCRIPTION OF EXAMPLE EMBODIMENTS

### Overview

A method is provided in one example embodiment and includes receiving audio data from a video conference and translating the audio data from a first language to a second language, wherein the translated audio data is played out during the video conference. The method also includes suppressing additional audio data until the translated audio data has been played out during the video conference. In more specific embodiments, the video conference includes at least a first end user, a second end user, and a third end user. In other embodiments, the method may include notifying the first and third end users of the translating of the audio data. The notifying can include generating an icon for a display being seen by the first and third end users, or using a light signal on a respective end user device configured to receive audio data from the first and third end users.

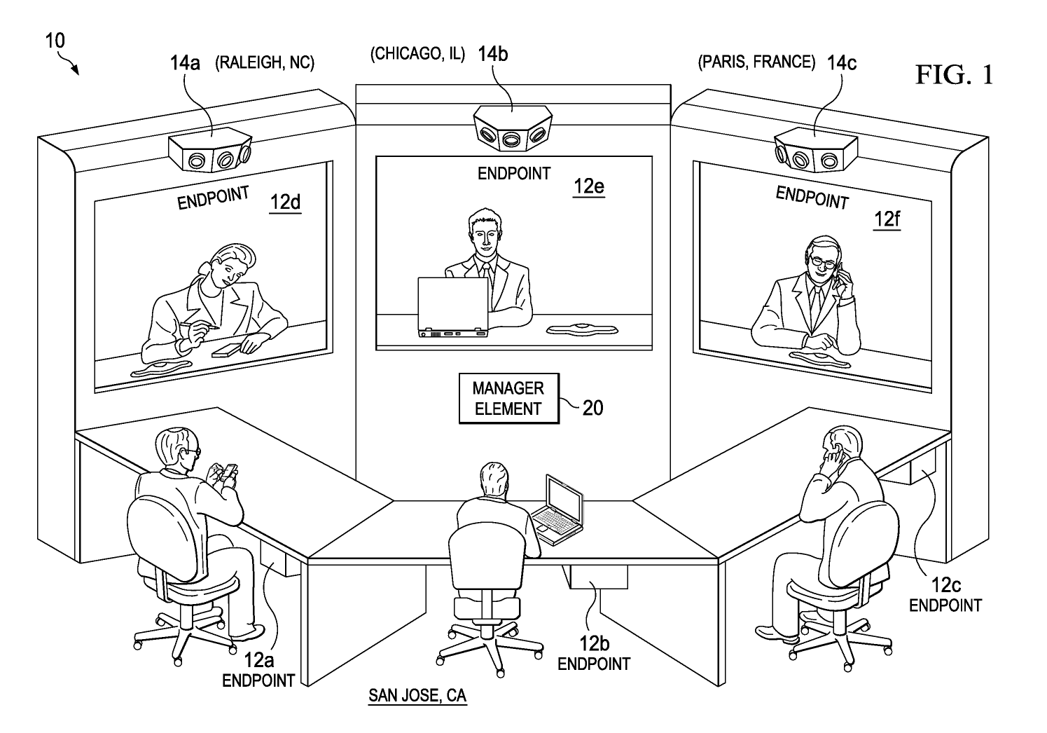

FIG. 1 is a simplified schematic diagram illustrating a communication system 10 for conducting a video conference in accordance with one example embodiment. FIG. 1 includes multiple endpoints, 12a-f associated with various participants of the video conference. In this example, endpoints 12a-c are located in San Jose, Calif., whereas endpoints 12d, 12e, and 12f are located in Raleigh, N.C., Chicago, Ill., and Paris, France respectively. FIG. 1 includes multiple endpoints 12a-c being coupled to a manager element 20. Note that the numerical and letter designations assigned to the endpoints do not connote any type of hierarchy; the designations are arbitrary and have been used for purposes of teaching only. These designations should not be construed in any way to limit their capabilities, functionalities, or applications in the potential environments that may benefit from the features of communication system 10.

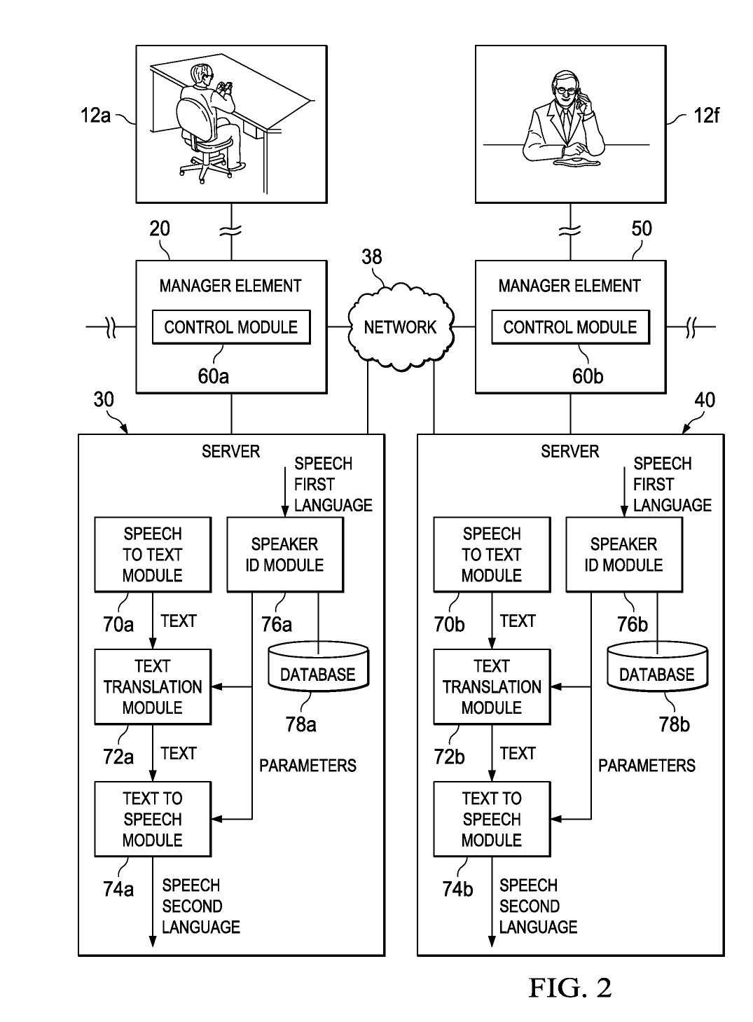

In this example, each endpoint 12a-f is fitted discreetly along a desk and is proximate to its associated participant. Such endpoints can be provided in any other suitable location, as FIG. 1 only offers one of a multitude of possible implementations for the concepts presented herein. In one example implementation, the endpoints are video conferencing endpoints, which can assist in receiving and communicating video and audio data. Other types of endpoints are certainly within the broad scope of the outlined concept and some of these example endpoints are further described below. Each endpoint 12a-f is configured to interface with a respective manager element, which helps to coordinate and to process information being transmitted by the participants. Details relating to each endpoint's possible internal components are provided below and details relating to manager element 20 and its potential operations are provided below with reference to FIG. 2.

As illustrated in FIG. 1, a number of cameras 14a-14c and screens are provided for the conference. These screens render images to be seen by the conference participants. Note that as used herein in this Specification, the term ‘screen’ is meant to connote any element that is capable of rendering an image during a video conference. This would necessarily be inclusive of any panel, plasma element, television, monitor, display, or any other suitable element that is capable of such rendering.

Note that before turning to the example flows and infrastructure of example embodiments of the present disclosure, a brief overview of the video conferencing architecture is provided for the audience. When more than two individuals engage in a video conferencing session, where multiple languages are being spoken, translation services are required. The translation services can be provided either by a person fluent in the spoken languages, or by computerized translation equipment.

When a translation occurs, there is certain delay as the language is communicated to a target recipient. Translation services work well in one-on-one environments, or when operating in a lecture mode when a single person speaks and a group listens. When only two end users are involved in such a scenario, there is a certain pacing that occurs in the conversation and the pacing is somewhat intuitive. For example, a first end user can naturally expect a modest delay as a translation occurs for the counterparty. Thus, as a rough estimate, the first end user can expect a long sentence to take a certain delay such that he should patiently wait until the translation has concluded (and possibly give the counterparty the option of responding) before speaking additional sentences.

This natural pacing becomes strained when translation services are provided in a multi-site videoconferencing environment. For example, if two end users were speaking English and the third end user were speaking German, as the first end user spoke an English phrase and the translation service began to translate the phrase for the German individual, the second English-speaking end user may inadvertently begin speaking in response to the previously spoken English phrase. This is fraught with problems. For example, at a minimum it is impolite to have this bantering occurring between two individuals sharing a native language, while a third party is several sentences behind the conversation. Second, this inhibits the entire collaborative nature of many videoconferencing scenarios that occur in business environments today as the third party's participation may be reduced to a listen only mode. Third, there could be some cultural inconsistencies or transgressions because two individuals can end up dominating or monopolizing a given conversation.

In example embodiments, system 10 can effectively remove limitations associated with these conventional videoconferencing configurations and, further, utilize translation services to conduct effective multi-site multilingual collaborations. System 10 can create a conferencing environment that ensures participants have an equal opportunity to contribute and to collaborate.

The following scenario illustrates the issues associated with translating within the context of a multi-site videoconferencing system (e.g., a multi-site TelePresence system). Assume a videoconferencing system employing three single-screen remote sites. John speaks English and he joins the video conference from site A. Bob also speaks English and joins the video conference from site B. Benoit speaks French and joins the video conference from site C. While John and Bob can freely converse without requiring translation (machine or human), Benoit requires an English/French translation during this video conference.

As the meeting starts, Bob openly asks: ‘What is the time?” John promptly responds: “10 AM.” This scenario highlights two user experience issues. First, existing video conferencing systems typically perform video switching based on voice activity detection (VAD). As soon as Bob completes his question, the automated translation machine comes up with the equivalent phrase in French and plays it to Benoit.

At the exact time the translated phrase is played, John quickly replies “10 AM.” Because the video conference is programmed to switch screens based on voice activity detection, Benoit sees John's face while he hears the French phrase: “What is the time?” There is some asymmetry engendered in this scenario because Benoit naturally assumes that John is inquiring about the time, when in fact John is answering Bob's question. Existing video teleconferencing systems create this inconsistency because they use traditional lip synchronization (and other ill-equipped protocols) to match voice and video processing time through the system. The VAD protocol frequently introduces confusion by switching the image from speaker A, while inconsistently providing a translated voice from speaker B. As illustrated above in a video teleconferencing system with translation, usability needs to be improved to ensure that viewers know what was said and, further, attribute this to the correct speaker.

Example embodiments offered can improve the switching algorithm in order to prevent the confusion caused by VAD-based protocols. Returning to this example flow, the fact that John could answer the question before Benoit had the opportunity to hear the translated question puts Benoit at a disadvantage with regard to cross-cultural cooperation. By the time Benoit attempts to answer Bob's question, the conversation between Bob and John may have progressed to another topic, which renders Benoit's input irrelevant. A more balanced system is needed when people from different cultures can collaborate as equals, without giving preferential treatment to any group.

Example embodiments presented herein can suppress voice input from users (other than the first speaker), while rendering a translated version (e.g., to Benoit). Such a solution can also notify the other users (whose voice inputs have been suppressed) about the fact that a translation is underway. This could ensure that all participants respect the higher priority of the automated translated voice and, further, inhibit talking directly over the translation. The notification offers a tool for delaying (slowing down) the progress of the conference to allow the translation to take place, where the image is intelligently rendered along with the image of the original speaker whose message is being translated.

Before turning to some of the additional operations of this architecture, a brief discussion is provided about some of the infrastructure of FIG. 1. Endpoint 12a is a client or a user wishing to participate in a video conference in communication system 10. The term ‘endpoint’ may be inclusive of devices used to initiate a communication, such as a switch, a console, a proprietary endpoint, a telephone, a camera, a microphone, a dial pad, a bridge, a computer, a personal digital assistant (PDA), a laptop or electronic notebook, or any other device, component, element, or object capable of initiating voice, audio, or data exchanges within communication system 10. The term ‘end user device’ may be inclusive of devices used to initiate a communication, such as an IP phone, an I-phone, a telephone, a cellular telephone, a computer, a PDA, a software or hardware dial pad, a keyboard, a remote control, a laptop or electronic notebook, or any other device, component, element, or object capable of initiating voice, audio, or data exchanges within communication system 10.

Endpoint 12a may also be inclusive of a suitable interface to the human user, such as a microphone, a camera, a display, or a keyboard or other terminal equipment. Endpoint 12a may also include any device that seeks to initiate a communication on behalf of another entity or element, such as a program, a database, or any other component, device, element, or object capable of initiating a voice or a data exchange within communication system 10. Data, as used herein in this document, refers to any type of video, numeric, voice, or script data, or any type of source or object code, or any other suitable information in any appropriate format that may be communicated from one point to another.

In this example, as illustrated in FIG. 2, endpoints in San Jose are configured to interface with manager element 20, which is coupled to a network 38. Please note that the endpoints may be coupled to the manager element via network 38 as well. Along similar rationales, endpoints in Paris, France are configured to interface with a manager element 50, which is similarly coupled to network 38. For purposes of simplification, endpoint 12a is described and its internal structure may be replicated in the other endpoints. Endpoint 12a may be configured to communicate with manager element 20, which is configured to facilitate network communications with network 38. Endpoint 12a can include a receiving module, a transmitting module, a processor, a memory, a network interface, one or more microphones, one or more cameras, a call initiation and acceptance facility such as a dial pad, one or more speakers, and one or more displays. Any one or more of these items may be consolidated or eliminated entirely, or varied considerably and those modifications may be made based on particular communication needs.

In operation, endpoints 12a-f can use technologies in conjunction with specialized applications and hardware to create a video conference that can leverage the network. System 10 can use the standard IP technology deployed in corporations and can run on an integrated voice, video, and data network. The system can also support high quality, real-time voice, and video communications with branch offices using broadband connections. It can further offer capabilities for ensuring quality of service (QoS), security, reliability, and high availability for high-bandwidth applications such as video. Power and Ethernet connections for all participants can be provided. Participants can use their laptops to access data for the meeting, join a meeting place protocol or a Web session, or stay connected to other applications throughout the meeting.

FIG. 2 is a simplified block diagram illustrating additional details related to an example infrastructure of communication system 10. FIG. 2 illustrates manager element 20 being coupled to network 38, which is also coupled to manager element 50 that is servicing endpoint 12f in Paris, France. Manager elements 20 and 50 may include control modules 60a and 60b respectively. Each manager element 20 and 50 may also be coupled to a respective server 30 and 40. For purposes of simplification, details relating to server 30 are explained, where such internal components can be replicated in server 40 in order to achieve the activities outlined herein. In one example implementation, server 30 includes a speech-to-text module 70a, a text translation module 72a, a text-to-speech module 74a, a speaker ID module 76a, and a database 78a. Collectively, this depiction offers a three-stage process for: speech-to-text recognition, text translation, and text-to-speech conversions. It should be noted that though servers 30 and 40 were depicted as two separate servers, alternatively the system can be configured with a single server performing the functionality of these two servers. Similarly, the concepts presented herein cover any hybrid arrangements of these two examples; namely, some components of servers 30 and 40 are consolidated into a single server and shared between the sites while other are distributed between the two servers.

In accordance with one embodiment, participants who require translation services can receive a delayed video stream. One aspect of an example configuration involves a video switching algorithm in a multi-party conferencing environment. In accordance with one example, rather than use participant's voice activity detection for video switching, the system gives the highest priority to the machine-translated voice. System 10 can also associate the image of the last speaker with the machine-generated voice. This ensures that all viewers see the image of the original speaker, as his message is being rendered in different languages to other listeners. Thus, a delayed video could show an image of the last speaker with an icon or banner advising viewing participants that the voice they are hearing is actually the machine-translated voice for the last speaker. Thus, the delayed video stream can be played out to a user who requires translation services so that he can see the person who has spoken. Such activities can provide a user interface that ensures that viewers attribute statements to specific videoconferencing participants (i.e., an end user can clearly identify who said what).

In addition, the configuration can alert participants who do not need translation that other participants have still not heard the same message. A visual indicator may be provided for users to be alerted of when all other users have been brought up to speed on the last statement made by a participant. In specific embodiments, the architecture mutes users who have heard a statement and prevents them from replying to the statement until everyone has heard the same message. In certain examples, the system notifies users via an icon on their video screen (or via an LED on their microphone, or via any other audio or visual means) that they are being muted.

The addition of an intelligent delay can effectively smooth or modulate the meeting such that all participants can interact with each other during the videoconference as equal members of one team. One example configuration involves servers 30 and 40 identifying the requisite delay needed to translate a given phrase or sentence. This could enable speech recognition activities to occur in roughly real-time. In another example implementation, servers 30 and 40 (e.g., via control modules 60a-60b) can effectively calculate and provide this intelligent delay.

In one example implementation, manager element 20 is a switch that executes some of the intelligent delay activities, as explained herein. In other examples, servers 30 and 40 execute the intelligent delay activities outlined herein. In other scenarios, these elements can combine their efforts or otherwise coordinate with each other to perform the intelligent delay activities associated with the described video conferencing operations.

In other scenarios, manager elements 20 and 50 and servers 30 and 40 could be replaced by virtually any network element, a proprietary device, or anything that is capable of facilitating an exchange or coordination of video and/or audio data (inclusive of the delay operations outlined herein). As used herein in this Specification, the term ‘manager element’ is meant to encompass switches, servers, routers, gateways, bridges, loadbalancers, or any other suitable device, network appliance, component, element, or object operable to exchange or process information in a video conferencing environment. Moreover, manager elements 20 and 50 and servers 30 and 40 may include any suitable hardware, software, components, modules, interfaces, or objects that facilitate the operations thereof. This may be inclusive of appropriate algorithms and communication protocols that allow for the effective delivery and coordination of data or information.

Manager elements 20 and 50 and servers 30 and 40 can be equipped with appropriate software to execute the described delaying operations in an example embodiment of the present disclosure. Memory elements and processors (which facilitate these outlined operations) may be included in these elements or be provided externally to these elements, or consolidated in any suitable fashion. The processors can readily execute code (software) for effectuating the activities described. Manager elements 20 and 50 and servers 30 and 40 could be multipoint devices that can affect a conversation or a call between one or more end users, which may be located in various other sites and locations. Manager elements 20 and 50 and servers 30 and 40 can also coordinate and process various policies involving endpoints 12. Manager elements 20 and 50 and servers 30 and 40 can include a component that determines how and which signals are to be routed to individual endpoints 12. Manager elements 20 and 50 and servers 30 and 40 can also determine how individual end users are seen by others involved in the video conference. Furthermore, manager elements 20 and 50 and servers 30 and 40 can control the timing and coordination of this activity. Manager elements 20 and 50 and servers 30 and 40 can also include a media layer that can copy information or data, which can be subsequently retransmitted or simply forwarded along to one or more endpoints 12.

The memory elements identified above can store information to be referenced by manager elements 20 and 50 and servers 30 and 40. As used herein in this document, the term ‘memory element’ is inclusive of any suitable database or storage medium (provided in any appropriate format) that is capable of maintaining information pertinent to the coordination and/or processing operations of manager elements 20 and 50 and servers 30 and 40. For example, the memory elements may store such information in an electronic register, diagram, record, index, list, or queue. Alternatively, the memory elements may keep such information in any suitable random access memory (RAM), read only memory (ROM), erasable programmable ROM (EPROM), electronically erasable PROM (EEPROM), application specific integrated circuit (ASIC), software, hardware, or in any other suitable component, device, element, or object where appropriate and based on particular needs.

As identified earlier, in one example implementation, manager elements 20 and 50 include software to achieve the extension operations, as outlined herein in this document. Additionally, servers 30 and 40 may include some software (e.g., reciprocating software or software that assists in the delay, icon coordination, muting activities, etc.) to help coordinate the video conferencing activities explained herein. In other embodiments, this processing and/or coordination feature may be provided external to these devices (manager element 20 and servers 30 and 40) or included in some other device to achieve this intended functionality. Alternatively, both manager elements 20 and 50 and servers 30 and 40 include this software (or reciprocating software) that can coordinate and/or process data in order to achieve the operations, as outlined herein.

Network 38 represents a series of points or nodes of interconnected communication paths for receiving and transmitting packets of information that propagate through communication system 10. Network 38 offers a communicative interface between sites (and/or endpoints) and may be any LAN, WLAN, MAN, WAN, or any other appropriate architecture or system that facilitates communications in a network environment. Network 38 implements a TCP/IP communication language protocol in a particular embodiment of the present disclosure; however, network 38 may alternatively implement any other suitable communication protocol for transmitting and receiving data packets within communication system 10. Note also that network 38 can accommodate any number of ancillary activities, which can accompany the video conference. For example, this network connectivity can facilitate all informational exchanges (e.g., notes, virtual white boards, PowerPoint presentations, e-mailing, word processing applications, etc.).

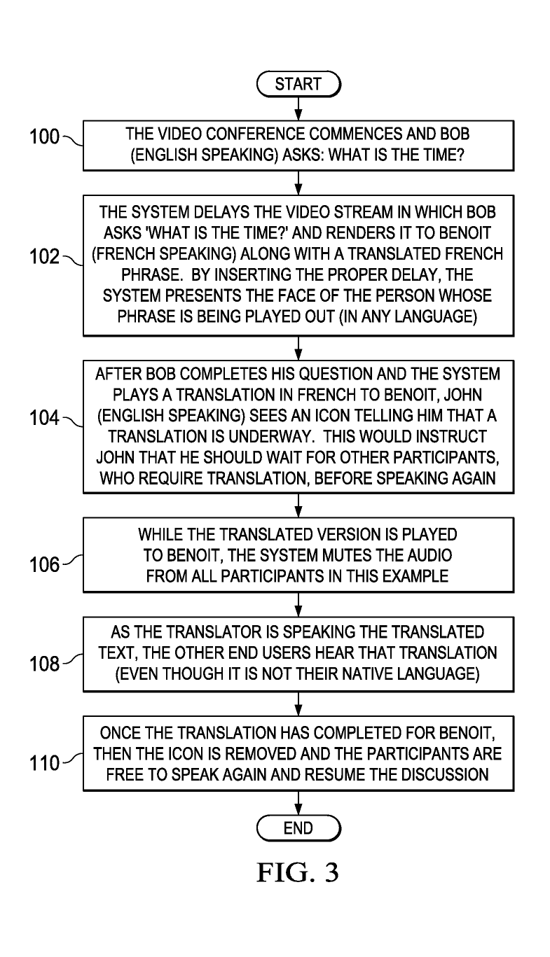

Turning to FIG. 3, an example flow involving some of the examples highlighted above is illustrated. The flow begins at step 100, when a video conference commences and Bob (English speaking) asks: What is the time? At step 102, system 10 delays the video stream in which Bob asks ‘What is the time?’ and renders it to Benoit (French speaking) along with a translated French phrase. In this example, lip synchronization is not relevant at this time because it becomes apparent that it is the translator (a machine or a person) and not Bob who is uttering the French phrase. By inserting the proper delay, system 10 presents the face of the person whose phrase is being played out (in any language).

For example, Bob's spoken English phrase may be translated to text via speech-to-text module 70a. That text may be converted to a second language (French in this example) via text translation module 72a. That translated text may then be converted to speech (French) via text-to-speech module 74a. Thus, a server or a manager element can assess the time delay, and then insert this delay. The delay can have effectively two parts; the first part assesses how long the actual translation would take, while the second part assesses how long it would take to play out this phrase. The second part would resemble a more normal, natural flow of language for the recipient. These two parts may be added together in order to determine a final delay to be inserted into the videoconference at this particular juncture.

In one example, these activities can be done by parallel processors in order to minimize the delay being inserted. Alternatively, such activities may simply occur on different servers to accomplish a similar minimization of delay. In other scenarios, there is a processor provided in manager elements 20 and 50, or in servers 30 and 40, such that each language has its own processor. This too could ameliorate the associated delay. Once the delay has been estimated and subsequently inserted, another component of the architecture operates to occupy end users who are not receiving the translated phrase or sentence.

In accordance one aspect of the system, after Bob completes his question and the system plays a translation in French to Benoit, John (English speaking) sees an icon telling him that a translation is underway. This would instruct John that he should wait for other participants, who require translation, before speaking again. This is illustrated by step 104. Indirectly, the icon is informing all participants not requiring a translation that they will not be able to inject further statements into this discussion until the translated information has been properly received.

In one embodiment, the indication to John is provided via an icon (text or symbols) that is displayed on John's screen. In another example embodiment, system 10 plays a low volume French version of Bob's question alerting John that Bob's question is being propagated to other participants and that John should wait with his reply until everyone has had an opportunity to hear the question.

While the translated version is played to Benoit, system 10 mutes the audio from all participants in this example. This is shown in step 106. To signal this muting, users can be notified via an icon on the screen, or the end user's endpoints could be involved (e.g., a speaker's red LED could indicate that their microphones have been muted until the translated phrase is played out). By muting the other participants, system 10 effectively prevents participants from moving forward, or having side conversations, before the end user awaiting the translation has heard the previous sentence or phrase.

Note that certain videoconferencing architectures include an algorithm that selects which speakers can be heard at a given time. For example, some architectures include a top-three paradigm in which only those speakers are allowed to have their audio stream sent into the forum of the meeting. Other protocols evaluate the loudest speakers before electing who should speak next. Example embodiments presented herein can leverage this technology in order to stop side conversations from occurring. For example, by leveraging such technology, audio communications would be prevented until the translation had completed.

More specifically, examples provided herein can develop a subset of media streams that would be permitted during specific segments of the videoconference, where other media streams would not be permitted in the meeting forum. In one example implementation, as the translator is speaking the translated text, the other end users hear that translation (even though it is not their native language). This is illustrated by step 108. While these other end users are not understanding necessarily what is being said, they are respecting the translator's voice and they are honoring the delay being introduced by this activity. Alternatively, the other end users do not hear this translation, but the other end users could receive some type of notification (such as “translation underway”), or be muted by the system.

In one example implementation, the configuration treats the automatically translated voice as a media stream, which other users cannot talk-over or preempt. In addition, system 10 is simultaneously providing that the image the listener sees is the one from the person whose translated message they are hearing. Returning to the flow of FIG. 3, once the translation has completed for Benoit, then the icon is removed (e.g., the endpoints will disable the mute function such that they can receive audio data again). The participants are free to speak again and the conversation can be resumed. This is shown in step 110.

In situations where there are three or more languages being spoken during a video conference, the system can respond by estimating the longest delay to be incurred in the translation activity, where all end users who are not receiving the translated information would be prevented from continuing the conversation until the last translation was completed. For example, if one particular user asked: “ . . . What is the expected shipping date of this particular product?”, the German translation for this sentence may be 6 seconds, whereas the French translation for this sentence may be 11 seconds. In this instance, the delay would be at least 11 seconds before other end users would be allowed to continue along in the meeting and inject new statements. Other timing parameters or timing criteria can certainly be employed and any such permutations are clearly within the scope of the presented concepts.

In example embodiments, communication system 10 can achieve a number of distinct advantages: some of which are intangible in nature. For example, there is a benefit of slowing down the discussion and ensuring that everyone can contribute, as opposed to reducing certain participants to a role of passive listener. Free flowing discussion has its virtues in a homogenous environment where all participants speak the same language. When participants do not speak the same language, it is essential to ensure that the entire team has the same information before the discussion continues to evolve. Without enforcing common information checkpoints (by delaying the progress of the conference to ensure that everyone shares the same common information), the team may be split into two sub-groups. One sub-group would participate in a fast exchange in the first language amongst the e.g., English speaking participants, while the other sub-group of participants, e.g., French speaking members, is reduced to a listen mode, as their understanding of the evolving discussion always lags behind the free flowing English conversation. By imposing a delay and slowing down the conversation, all meeting participants have the opportunity to fully participate and contribute.

Note that with the example provided above, as well as numerous other examples provided herein, interaction may be described in terms of two or three elements. However, this has been done for purposes of clarity and example only. In certain cases, it may be easier to describe one or more of the functionalities of a given set of flows by only referencing a limited number of network elements. It should be appreciated that communication system 10 (and its teachings) are readily scalable and can accommodate a large number of endpoints, as well as more complicated/sophisticated arrangements and configurations. Accordingly, the examples provided should not limit the scope or inhibit the broad teachings of communication system 10 as potentially applied to a myriad of other architectures.

It is also important to note that the steps discussed with reference to FIGS. 1-3 illustrate only some of the possible scenarios that may be executed by, or within, communication system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. For example, once the delay mechanism is initiated, then the muting and icon provisioning may occur relatively simultaneously. The preceding operational flows have been offered for purposes of example and discussion. Substantial flexibility is provided by communication system 10 in that any suitable arrangements, chronologies, configurations, and timing mechanisms may be provided without departing from the teachings of the present disclosure.

Although the present disclosure has been described in detail with reference to particular embodiments, it should be understood that various other changes, substitutions, and alterations may be made hereto without departing from the spirit and scope of the present disclosure. For example, although the present disclosure has been described as operating in video conferencing environments or arrangements, the present disclosure may be used in any communications environment that could benefit from such technology. Virtually any configuration that seeks to intelligently translate data could enjoy the benefits of the present disclosure. Moreover, the architecture can be implemented in any system providing translation for one or more endpoints. In addition, although some of the previous examples have involved specific terms relating to the TelePresence platform, the idea/scheme is portable to a much broader domain: whether it is other video conferencing products, smart telephony devices, etc. Moreover, although communication system 10 has been illustrated with reference to particular elements and operations that facilitate the communication process, these elements and operations may be replaced by any suitable architecture or process that achieves the intended functionality of communication system 10.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112a as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
receiving audio data from a video conference;
translating the audio data from a first language to a second language, wherein the translated audio data is played out during the video conference; and
suppressing additional audio data until the translated audio data has been played out during the video conference.

2. The method of claim 1, wherein the video conference includes at least a first end user, a second end user, and a third end user.

3. The method of claim 2, further comprising:
notifying the first and third end users of the translating of the audio data, and wherein the notifying includes generating an icon for a display being seen by the first and third end users, or the notifying includes using a light signal on a respective end user device configured to receive audio data from the first and third end users.

4. The method of claim 2, wherein during the translating of the audio data, a video image associated with the first end user is displayed to the second and third end users and a video stream for the second and third end users are delayed.

5. The method of claim 2, wherein video switching for the end users during the video conference includes assigning a highest priority to machine-translated voice data associated with the translated audio data.

6. The method of claim 2, wherein the suppressing of the audio data includes muting end user devices operated by the first and third end users.

7. The method of claim 2, wherein the suppressing of the audio data includes inserting a delay before permitting the first and third end users to have their subsequent audio data received into the video conference, and wherein the delay includes a processing time period for translating the audio data of the first end user and a time period for playing out the translated audio data to the second end user.

8. An apparatus, comprising:
a manager element configured to receive audio data from a video conference, wherein the audio data is translated from a first language to a second language and played out during the video conference, the manager element including a control module configured to suppress additional audio data until the translated audio data has been played during the video conference.

9. The apparatus of claim 8, wherein the video conference includes at least a first end user, a second end user, and a third end user.

10. The apparatus of claim 9, wherein during the translating of the audio data, a video image associated with the first end user is displayed to the second and third end users and a video stream for the second and third end users are delayed.

11. The apparatus of claim 9, wherein the manager element is configured to perform video switching for the end users during the video conference and the switching includes assigning a highest priority to machine-translated voice data associated with the translated audio data.

12. The apparatus of claim 9, wherein the manager element is configured to mute end user devices operated by the first and third end users.

13. The apparatus of claim 9, wherein the manager element is configured to insert a delay before permitting the first and third end users to have their subsequent audio data received into the video conference, and wherein the delay includes a processing time period for translating the audio data of the first end user and a time period for playing out the translated audio data to the second end user.

14. The apparatus of claim 9, wherein the manager element is configured to provide the first and third end users with the translated audio data, being played out to the second end user, at a reduced volume.

15. Logic encoded in one or more tangible media for execution and when executed by a processor operable to:
receive audio data from a video conference;
translate the audio data from a first language to a second language, wherein the translated audio data is played out during the video conference; and
suppress additional audio data until the translated audio data has been played out during the video conference.

16. The logic of claim 15, wherein the video conference includes at least a first end user, a second end user, and a third end user.

17. The logic of claim 16, wherein during the translating of the audio data, a video image associated with the first end user is displayed to the second and third end users and a video stream for the second and third end users are delayed.

18. The logic of claim 16, wherein video switching for the end users during the video conference includes assigning a highest priority to machine-translated voice data associated with the translated audio data.

19. The logic of claim 16, wherein the suppressing of the audio data includes muting end user devices operated by the first and third end users.

20. The logic of claim 16, wherein the suppressing of the audio data includes inserting a delay before permitting the first and third end users to have their subsequent audio data received into the video conference, and wherein the delay includes a processing time period for translating the audio data of the first end user and a time period for playing out the translated audio data to the second end user.

21. A system, comprising:
means for receiving audio data from a video conference;
means for translating the audio data from a first language to a second language, wherein the translated audio data is played out during the video conference; and
means for suppressing additional audio data until the translated audio data has been played out during the video conference.

22. The system of claim 21, wherein the video conference includes at least a first end user, a second end user, and a third end user.

23. The system of claim 22, wherein during the translating of the audio data, a video image associated with the first end user is displayed to the second and third end users and a video stream for the second and third end users are delayed.

24. The system of claim 22, wherein video switching for the end users during the video conference includes assigning a highest priority to machine-translated voice data associated with the translated audio data.

25. The system of claim 22, wherein the means for suppressing the audio data includes inserting a delay before permitting the first and third end users to have their subsequent audio data received into the video conference, and wherein the delay includes a processing time period for translating the audio data of the first end user and a time period for playing out the translated audio data to the second end user.
